(19) United States
(12) Patent Application Publication
(10) Pub. No.: US 2010/0042611 A1
(43) Pub. Date: Feb. 18, 2010

(54) Location-based search mash-up engine, web site, and application programming interface

(76) Inventor: Nazareno Brier Cruzada, Carlsbad, CA (US)

Correspondence Address: Nazareno Cruzada, 3505 Avenida Maravilla, Carlsbad, CA, 92009, US

(21) Appl. No.: 12/193,669

(22) Filed: Aug. 18, 2008

(51) Int. Cl. G06F 17/30

(52) U.S. Cl. 707/5; 707/E17.109; 719/328

(57) ABSTRACT

This invention is a location-based search mash-up engine, web site, and application programming interface (API) for use by web browsers or programs running on wireless mobile devices with web or internet access and location finding capability such as GPS and cell tower or Wi-Fi hotspot triangulation. The invention also provides the capability of presenting sponsored listings or coupons with the search results. The logic to choose these sponsored business listings or coupons will be based on keywords associated with a specific location, defined by latitude & longitude and surrounding radius defined by meters or fractions of a mile (¼ mile, ½ mile, etc.) or kilometer.

### BACKGROUND OF THE INVENTION

1. Field of the Invention

Online or web search has been a very popular and often central part of a typical user's online or web experience. The usability, and therefore the popularity, of a search engine has mostly been based on the quality and level of relevance of its search results. As online or web search goes from a desktop search model to that of a mobile search model, the context of the user's search changes. In a mobile search model, the search is usually conducted away from home or work and the user's search is usually centered around finding a point of interest or business that is located close by or an event that is not only close by but one that is currently occurring or will occur within a short period of time from the current time of the search. The ability to narrow down the search to information regarding these types of entities & filter the results based on a specific location and/or time provided becomes a very important & key feature.

2. Description of the Prior Art

In the context of a desktop search, the user can be searching for anything & everything. The search is based mostly on a specific keyword or keywords. The user might be searching for websites with content or information that can help them make a better decision regarding a purchase of a car or HDTV that they plan to make in the next month or so. The user might be doing research for a school or work project, looking for information about a particular person or institution, or be looking for the nearest Home Depot or Best Buy. Whatever the context of the search is, most search engines cast a wide net by default since the assumption is that the nature of a typical desktop search is one of research of what exists and is available out on the web and not a search that is based on time or location.

In the recent years, the popularity of conducting searches using web connected mobile devices and smartphones have become more popular. As such, the significance and huge commercial potential of mobile search has come to the attention of the search engine, software & technology industry. However, there are key differences between desktop search and mobile search that need to be taken into consideration when entering the mobile search space.

The sensitivity of mobile search to location & time is important since a user conducting a mobile search has more immediate & distance sensitive needs. The user might be a business person getting out of a conference downtown and is looking for the closest Kinko's or a couple looking for a good restaurant close by after having finished watching a movie. In the context of desktop search, typing in the word ‘sushi’ would get search results that include the definition of the word, recipes or articles on how to make sushi, or perhaps sushi-making classes. In the context of mobile search, a user typing in ‘sushi’ is probably looking for a sushi restaurant nearby and not the definition of the word.

In the recent years, search engines and web sites that provide search results based on a particular location or time have come into existence. Web sites such as Earthcomber.com, ULocate.com, Where.com, and Rummble.com are examples. Also, some traditional desktop search engine companies have evolved their search engine services to provide location or time based search services & applications. These services & applications include location-based searches as well as mapping web sites & services. These online search engines and mapping applications—such as Google Maps, Yahoo Maps, and Microsoft Live Maps—provide location-based mobile searches based on a particular city, zip code, or street intersection. They can narrow down the search results by providing a list of business listings or points of interest (POIs) within a given proximity of the given location.

There are also websites that provide a calendar of events or a specific category of information based on a particular city or zip code such as concert listings or restaurant reviews. Websites such as Yelp.com, SomethingTUDU.com, and Eventful.com are examples of such sites.

These types of search engines and websites increase the relevance of the search results for the user by narrowing down the results based on a specific location, which addresses the location or time specific search results that mobile search usually requires. The problem with the existence of these many websites & search engines is that the mobile search user is faced with the task of finding & deciding which websites or search engines to use, especially if their search is based on something interesting to do near a specific location. If the user wants to search for business listings or points of interest close by such as parks, historical sites or landmarks, they would have to go to a specific mapping search engine. If the user wants to search for a list of restaurants close by that has other users' reviews, they would have to go to another search engine or web site. If the user wants to search for events close by they would have to go to yet another search engine or web site. This problem is also exacerbated since the mobile search has a time sensitive factor to it. The user does not have days or even hours to conduct the search and usually does not have the time or preference to go to all the different web sites and search engines to gather all this information. Another problem with having to go to & use multiple websites or search engines is that these websites & search engines have differing layouts and search result information formats that makes the search disorganized, confusing & daunting.

In the light of these problems with the current search options available to location-based mobile search, a web-based system that provides a search engine that stores these location-based information locally, integrates & communicates with other (remote) search engines & websites, and then mashes up the local & remote search results into one standard format and makes it available from one central website and application programming interface (API) can provide considerable value.

### SUMMARY OF THE INVENTION

This invention is a location-based search mash-up engine, web site, and application programming interface (API) for use by web browsers or programs running on wireless mobile devices with web or internet access and location finding capability such as GPS and cell tower or Wi-Fi hotspot triangulation. The invention also provides the capability of presenting sponsored listings or coupons with the search results. The logic to choose these sponsored business listings or coupons will be based on keywords associated with a specific location, defined by latitude & longitude and surrounding radius defined by meters or fractions of a mile or kilometer (¼ mile, ½ mile, etc.).

The web site allows users to search for & be provided with information regarding points of interest, events, and businesses based on keywords that they provide and their specific location, using a web browser on their personal mobile devices that have web or internet access. The application programming interface (API) allows developers of third party software to integrate & communicate with the system, and therefore have the ability to request mash-up searches from the applications & programs that they develop. The search mash-up engine integrates & communicates with other (remote) search engines and web sites and sends search query requests to retrieve category specific and location-based search results from each one. The search mash-up engine may retrieve business listings & points of interest from local databases or remote mapping search engines as well as event or activity listings from local databases or remote location-based events search engines or calendaring web sites. The web site & the application programming interface both communicate with and use the search mash-up engine to request & receive search results.

The web site is composed of a search form web page and a search results web page. The search form web page accepts search parameters including the keyword or keywords to search by, the latitude & longitude of the location to base the search on, and the radius of the search. The search results web page will have a multi-stage presentation scheme to allow faster presentation of the search results to the user. The functionality of this multi-stage presentation scheme allows the search results web page to present search information and records that are stored locally in the system while background processes in the search mash-up engine continue to run queries on remote web search engines, web services and web sites to retrieve other mash-up search results & information. Sponsored listings, coupons, and points of interest are examples of locally stored records. These records may be returned first and shown on the search results page along with buttons for an events search and business listings search. If the user clicks on either button, the search results page will retrieve the appropriate records from the background processes in the search mash-up engine then displays them to the user.

The application programming interface (API) is a web service that provides similar functionality as the search form web page as it accepts search parameters including the keyword or keywords to search by, the latitude & longitude of the location to base the search on, and the radius of the search. It also provides multi-stage search capability by allowing a filtering or narrowing of the search to specific categories such as points of interest, business listings, events, and sponsored listings.

### DETAILED DESCRIPTION OF THE INVENTION

The invention is an electronic communication system that is comprised of:
1. a website
2. an application programming interface (API)
3. a local database of points of interest
4. a local database of sponsored listings & coupons
5. a local database of events, activities, & things to do
6. a location-based search mash-up engine that integrates with remote search engines & websites, queries both local databases & remote engines & websites, then mashes up the local & remote search results into one standard format
7. a module consisting of web pages that allow the creation & management of a location-based sponsored listing or coupon account
8. a module consisting of web pages that allow the creation & management of a location-based event or activity listing account
9. a system administration module

This invention is specifically designed for location-based mobile searches and is for use by web browsers or programs running on wireless mobile devices with web or internet access and location finding capability such as GPS and cell tower or Wi-Fi hotspot triangulation.

The web site allows users to send their location information (latitude & longitude and search radius), then search for & be provided with information regarding points of interest, events, and businesses based on keywords that they provide and their specific location, using a web browser on their personal mobile devices that have web or internet access. The application programming interface (API) allows developers of third party software to integrate & communicate with the system, and therefore have the ability to request mash-up searches from the applications & programs that they develop. The search mash-up engine integrates & communicates with other (remote) search engines and web sites and sends search query requests to retrieve category specific and location-based search results from each one, then combines the various search results data into one standard format. The search mash-up engine may retrieve sponsored listings & points of interest from local databases; business listings from local databases or remote location-based search engines; as well as event & activity listings from local databases or remote location-based events search engines or calendaring web sites.

The web site is composed of a search form web page and a search results web page. The search form web page accepts search parameters including the keyword or keywords to search by, the latitude & longitude of the location to base the search on, and the radius of the search. The search form web page consists of text input boxes that a user can type into, a dropdown listbox to help narrow down the search to a specific search category (e.g.: Points of Interest, Events, Activities, Business Listings, or Search All), and a button to launch the search. It also has functionality to accept search parameter values from browsers and other applications. These parameters include keywords, latitude, longitude, and search radius. If these parameters are passed to the search form web page, the parameter values will be displayed inside the text input boxes. This display will serve as a confirmation that the parameter values passed were received properly and will also allow the user to modify them.

The search results web page will have a multi-stage presentation scheme to allow faster presentation of the search results to the user. The functionality of this multi-stage presentation scheme allows the search results web page to quickly present search information and records that are stored locally in the system while background processes in the search mash-up engine continue to run queries on remote web search engines, web services and web sites to retrieve other mash-up search results & information. Sponsored listings and points of interest are examples of locally stored records. Since the locally stored points of interest data will include a wide array of categories & sub-categories from landmarks, parks & historical sites to business & commercial listings, the search results records from this data will satisfy & provide relevant results for most searches. As such, these records may be returned first and shown on the search results page along with buttons for an events search and business listings search in the case the user does not find any of the search results satisfying or relevant. If the user clicks on either button, the search results page will retrieve the appropriate records from the background processes in the search mash-up engine then displays them to the user.

If the user chooses the ‘Events’, ‘Activities’ or ‘Business Listings’ options from the dropdown listbox, then the local database as well as the remote web search engines, web services, or web sites offering location-based searches for that specific chosen option will be queried. If search results records are found, these records will be shown on the search results page along with buttons for a ‘Points of Interest’ search as well as an ‘Events’, ‘Activities’ or ‘Business Listings’ search—whichever one of the two wasn't chosen. If there are no search results from the local points of interest database, then the search results web page will wait for the background processes in the search mash-up engine to finish searching for any events or business listings search results from the remote web search engines, web services, or web sites.

The application programming interface (API) is a web service that provides similar functionality to the search form web page as it accepts search parameters including the keyword or keywords to search by, the latitude & longitude of the location to base the search on, and the radius of the search. It also provides multi-stage search capability by allowing a filtering or narrowing of the search to specific categories such as points of interest, business listings, events, and sponsored listings. The application programming interface can support proprietary and industry standard messaging & data protocols over HTTP including but not limited to SOAP, REST, & XML. The application programming interface communicates directly with the search mash-up engine to request the search.

The search mash-up engine provides search results data by querying local databases as well as remote search engines, web services, & web sites. It provides the core value of the system in that it conducts multiple searches of local databases as well as remote location-based search engines, web services, & web sites as one search and then combines the multitude of search results into one standard format, all available from one central web site or application programming interface. It has the capability and logic to support multi-stage availability of search results by sending search results data that it retrieves the soonest back to the web site or application programming interface, while at the same time continuing to run asynchronous searches on the other search data sources within the context of a search session. If search mash-up engine receives search results data from the local points of interest database sooner than from the remote search engines, web services, or web sites it will immediately send this data as a response back to the requesting component of the system (the web site or the application programming interface) while at the same time continuing to asynchronously run the search on the other search data sources. If the user requests more search results data within the same search session, the asynchronously running searches will have been done and the search results data will then be available. If the user starts a new search within the same search session, the previous asynchronously running searches will be stopped and new ones will be run for the new search.

The invention is designed to operate as a commercial concern and therefore provides the capability of presenting sponsored listings or coupons with the search results. The logic to choose these sponsored listings or coupons will be based on keywords associated with a specific location, defined by latitude & longitude and surrounding radius defined by meters or fractions of a mile (¼ mile, ½ mile, etc.) or kilometer. Entities who want to have a sponsored listing or coupon presented on the search results web page of the web site or be included in the search results data returned by the application programming interface can choose or define a specific listing based on a combination of a keyword or keywords such as ‘pizza’ or ‘chicago pizza’, a specific latitude/longitude combination such as 41° 59′ N/87° 54′ W or 41°52′43″ Latitude/−87°38′11″ Longitude, and a specific radius. A sponsored listing record in the database will have the information above as well as a short description of the listing (e.g: “Chicago's First Pizza Parlor. Family owned since 1840.”). For coupons, the database record will have a short description of the business as well as a description of the coupon, e.g: “30% off all merchandise” or “Buy one get one free”. A tiered pricing structure can be applied, e.g: a smaller radius (e.g.: ¼ mile) or a general or one-word keyword (e.g: ‘pizza’) may have a higher price than a larger radius (½ mile) or a more specific keyword phrase (e.g: ‘chicago pizza’).

These sponsored listings or coupons are on a rotation schedule, with 1-3 sponsored listings or coupons being returned per search by the search mash-up engine and either presented on the search results web page or as part of the search results returned by the application programming interface. A rotation schedule logic in the search mash-up engine will ensure that a different set of sponsored listings or coupons will be shown for each individual search. This allows the definition & storing of an unlimited number of sponsors per keyword, latitude/longitude and radius combination.

A system administration module will allow the administration of the entire system, including monitoring of the web site & API traffic, search mash-up engine performance and the adding, editing, & deleting of sponsored listings, coupons, points of interest, events, & activities.

### BRIEF DESCRIPTION OF THE DRAWINGS

FIG. 1 is a high level diagram of the system including the setup, composition, linkages, and relationships of the central server application as well as the setup, composition, linkages, and relationships of the first and second wireless mobile devices.

The components of the system as outlined in the drawing are:
1. The central server application
2. The screens for adding, retrieving or updating user profiles
3. Extraction and mapping process for user profile data from external website
4. Central server application database to store encrypted user profile data
5.

[symbol]

What is claimed is:

1. An electronic communications system that is comprised of:
a) a website;
b) an application programming interface (API);
c) a local database of points of interest;
d) a local database of sponsored listings & coupons;
e) a local database of events, activities, & things to do;
f) a location-based search mash-up engine that integrates with remote search engines & websites, queries both local databases & remote engines & websites, then mashes up the local & remote search results into one standard format;
g) a module consisting of web pages that allow the creation & management of a location-based sponsored listing or coupon account
h) a module consisting of web pages that allow the creation & management of a location-based event or activity listing account
i) a system administration module;

2. A method of the system of claim 1 that allows users to send their location information (latitude & longitude and optionally search radius), then search for & be provided with information regarding points of interest, events, activities, and businesses based on keywords that they provide and their specific location, using a web browser on their personal mobile devices that have web or internet access.

3. The website component of the system of claim 1 that is composed of a search form web page and a search results web page. The search form web page accepts search parameters including the keyword or keywords to search by, the latitude & longitude of the location to base the search on, and the radius of the search. The search form web page consists of text input boxes that a user can type into, a dropdown listbox to help narrow down the search to a specific search category (e.g.: Points of Interest, Events, Activities, Business Listings, or Search All), and a button to launch the search. It also has functionality to accept search parameter values from browsers and other applications. These parameters include keywords, latitude, longitude, and search radius. If these parameters are passed to the search form web page, the parameter values will be displayed inside the text input boxes. This display will serve as a confirmation that the parameter values passed were received properly and will also allow the user to modify them.

4. A method of the system component of claim 3 wherein the search results web page will have a multi-stage presentation scheme to allow faster presentation of the search results to the user. The functionality of this multi-stage presentation scheme allows the search results web page to quickly present search information and records that are stored locally in the system while background processes in the search mash-up engine continue to run queries on remote web search engines, web services and web sites to retrieve other mash-up search results & information. Sponsored listings, coupons, events, activities, and points of interest are examples of locally stored records. Since the locally stored points of interest data will include a wide array of categories & sub-categories from landmarks, parks & historical sites to business & commercial listings, the search results records from this data will satisfy & provide relevant results for most searches. As such, these records may be returned first and shown on the search results page along with buttons for an events search and business listings search in the case the user does not find any of the search results satisfying or relevant. If the user clicks on either button, the search results page will retrieve the appropriate records from the background processes in the search mash-up engine then displays them to the user. If the user chooses the ‘Events’, ‘Activities’ or ‘Business Listings’ options from the dropdown listbox, then the local points of interest database will not be searched. Instead, the remote web search engines, web services, or web sites offering location-based searches for that specific chosen option will be queried. If search results records are found, these records will be shown on the search results page along with buttons for a ‘Points of Interest’ search as well as an ‘Events’, ‘Activities’ or ‘Business Listings’ search—whichever one of the three wasn't chosen. If there are no points of interest search results, then the search results web page will wait for the background processes in the search mash-up engine to finish searching for any events or business listings search results from the remote web search engines, web services, or web sites.

5. A method of the application programming interface (API) component of the system of claim 1 that allows developers of third party software to integrate & communicate with the system, and therefore have the ability to request mash-up searches from the applications & programs that they develop. The application programming interface (API) is a web service that provides similar functionality to the search form web page as it accepts search parameters including the keyword or keywords to search by, the latitude & longitude of the location to base the search on, and the radius of the search. It also provides multi-stage search capability by allowing a filtering or narrowing of the search to specific categories such as points of interest, business listings, events, and sponsored listings. The application programming interface can support proprietary and industry standard messaging & data protocols over HTTP including but not limited to SOAP, REST, & XML. The application programming interface communicates directly with the search mash-up engine to request the search.

6. A method of the location-based search mash-up engine component of the system of claim 1 that provides search results data by querying local databases as well as remote search engines, web services, & web sites, then mashes up the local & remote search results into one standard format.

7. A method of the location-based search mash-up engine component of the system of claim 1 wherein the search mash-up engine retrieves sponsored listings & points of interest from local databases; business listings from local databases or remote location-based search engines; as well as event & activity listings from local databases or remote location-based events search engines or calendaring web sites.

8. A method of the location-based search mash-up engine component of the system of claim 1 wherein the search mash-up engine that integrates & communicates with remote search engines and web sites and sends search query requests to retrieve category specific and location-based search results from each one, then combines the various search results data into one standard format.

9. A method of the location-based search mash-up engine component of the system of claim 1 wherein the search mash-up engine conducts multiple searches of local databases as well as remote location-based search engines, web services, & web sites as one search and then combines the multitude of search results into one standard format, all available from one central web site or application programming interface. This method has the capability and logic to support multi-stage availability of search results by sending search results data that it retrieves the soonest back to the web site or application programming interface, while at the same time continuing to run asynchronous searches on the other search data sources. If the search mash-up engine receives search results data from the local points of interest database sooner than from the remote search engines, web services, or web sites it may immediately send this data as a response back to the requesting component of the system (the web site or the application programming interface) while at the same time continuing to asynchronously run the search on the other search data sources within the context of a search session. If the user requests more search results data within the same search session, the asynchronously running searches will have been done and the search results data will then be available. If the user starts a new search within the same search session, the previous asynchronously running searches will be stopped and new ones will be run for the new search.

10. The system of claim 1 wherein the local database of points of interest data comprises a wide array of categories & sub-categories including public entities such as landmarks, parks, historical sites as well as business & commercial listings such as bars, restaurants, activity venues, & clubs.

11. A method of the website and local database of sponsored listings and coupons components of the system of claim 1 wherein entities who want to have a sponsored listing or coupon presented on the search results web page of the web site or be included in the search results data returned by the application programming interface can choose or define a specific listing based on a combination of a keyword or keywords such as ‘pizza’ or ‘chicago pizza’, a specific latitude/longitude combination such as 41° 59′ N/87° 54′ W or 41°52′43″ Latitude/−87°38′11″ Longitude, and a specific radius. A sponsored listing record in the database will have the information above as well as a short description of the listing (e.g: “Chicago's First Pizza Parlor. Family owned since 1840.”). For coupons, the database record will have a short description of the business as well as a description of the coupon, e.g: “30% off all merchandise” or “Buy one get one free”. A tiered pricing structure for the sponsoring of these listings or coupons can be applied, e.g: a smaller radius (e.g.: ¼ mile) or a general or one-word keyword (e.g: ‘pizza’) may have a higher price than a larger radius (½ mile) or a more specific keyword phrase (e.g: ‘chicago pizza’).

12. A method of the location-based search mash-up engine component of the system of claim 1 wherein the logic to choose sponsored listings or coupons will be based on keywords associated with a specific location, defined by latitude & longitude and surrounding radius defined by meters or fractions of a mile (¼ mile, ½ mile, etc.) or kilometer.

13. A method of the location-based search mash-up engine component of the system of claim 1 wherein the search mash-up engine will return the sponsored listings or coupons on a rotation schedule, with 1-3 sponsored listings or coupons being returned per search. A rotation schedule logic in the search mash-up engine will ensure that a different set of sponsored listings or coupons will be shown for each individual search. This allows the definition & storing of an unlimited number of sponsors per keyword, latitude/longitude and radius combination.

14. A method of the system administration module component of the system of claim 1 that will allow the administration of the entire system; including monitoring of the web site & API traffic, search mash-up engine performance and the adding, editing, & deleting of sponsored listings, coupons, points of interest, events, & activities.
